(19) United States
(12) Patent Application Publication
(10) Pub. No.: US 2006/0256672 A1
(43) Pub. Date: Nov. 16, 2006

(54) Optical disk device and method for performing focus draw-in operation thereon

(75) Inventor: Motoyuki Suzuki, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 11/295,051

(22) Filed: Dec. 5, 2005

(30) Foreign Application Priority Data
May 12, 2005 (JP) 2005-139226

(51) Int. Cl. G11B 7/00

(52) U.S. Cl. 369/44.28

(57) ABSTRACT

An optical disk device and a focus draw-in method for the same, the device consists of a sum signal generator and a lens velocity control circuit for controlling a relative velocity of an optical disk and an objective lens based on a sum signal, for performing control so that a relative velocity of a recording surface of the optical disk and the objective lens may stably fall in a predetermined draw-in enabled range before control of the objective lens is switched to focus control by use of a focus error signal, to enable stabilizing a draw-in operation.

### INCORPORATION BY REFERENCE

The present application claims priority from Japanese application JP2005-139226 filed on May 12, 2005, the content of which is hereby incorporated by reference into this application.

### BACKGROUND OF THE INVENTION

1. Field of the Invention

The present invention relates to an optical disk device for irradiating an optical disk with a light spot to record or reproduce information and, more specifically, a focus draw-in (or pull-in) device for moving an objective lens from an initial position to an in-focus position and then controlling the objective lens in such a manner as to maintain an in-focus state on a recording surface of the disk.

2. Description of the Related Art

In a conventional focus draw-in device, the above-described configuration is used to drive an objective lens 108 perpendicular to a recording surface of an optical disk 100, thereby realizing a focus draw-in operation. This is described below in detail with reference to FIG. 10.

In focus control draw-in, first an in-focus state detector 105 is used to switch an output signal of a switch SW to an output signal of a sweep signal generator 104. First, a sweep signal that increases in a negative direction is output from the sweep signal generator 104 to move the objective lens 108 to a bottom point once and then a sweep signal that increases in a positive direction is output therefrom to raise the objective lens 108 so that it may approach the recording surface of the disk. In the in-focus state detector 105, the output signal of the switch SW is switched to an output signal of a focus control circuit 103 when a focus error signal FE from a focus error signal generator circuit 102 exceeds a predetermined level FEth and then the objective lens 108 reaches an in-focus position to reduce the focus error signal to about 0. In such a manner, the objective lens 108 is switched to a focus control operation by means of an output of the focus control circuit 103, thereby completing the focus draw-in operation.

An example that shows a conventional technology is disclosed in JP-A-11-144260.

### SUMMARY OF THE INVENTION

In recent years, optical disk devices have been used to record or reproduce video signals, sound signals, and data of a computer.

Hereinafter, an example of a conventional focus draw-in system used in an optical disk device will be described with reference to drawings. First, as an example of a method to detect a focus error signal, an astigmatic method which utilizes astigmatism of an optical system will be explained with reference to FIGS. 7A through 7C.

In the astigmatic method, a four-element detector is provided at a position where the cross section of a reflected light in an astigmatic optical system becomes circle when a recording surface of the optical disk is positioned at a focus point of an objective lens, and four sensor signals (here, the four sensor signals are referred to as a sensor signal A, a sensor signal B, a sensor signal C, and a sensor signal D, respectively) are arithmetically combined by an arithmetic circuit to thereby obtain a focus error signal FE [here, FE is generated as FE=(C+D)−(A+B)]. Hereinafter, a brief description will be made on the focus error signal of the astigmatic method.

As shown in FIG. 7B, when the recording surface of the optical disk is at an in-focus state position of the objective lens, the cross section of a beam on the four-element detector becomes circle, so that the focus error signal FE becomes zero [because (A+B)=(C+D)].

As shown in FIG. 7C, when the objective lens moves close to the optical disc, the cross section of the reflected light on the four-element detector becomes a vertically long ellipse, so that the focus error signal FE becomes negative value [because (A+B)>(C+D)].

As shown in FIG. 7A, when the objective lens moves away from the optical disk, the cross section of the reflected light on the four-element detector becomes horizontally long ellipse, so that the focus error signal FE becomes positive value [because (A+B)<(C+D)].

Further, when the objective lens significantly deviates from the in-focus state position, all of the output signals of the four-element detector become zero since the reflected light from the optical disk diffuses, so that the focus error signal FE becomes zero.

FIG. 8 shows change characteristics of the focus error signal FE with respect to a distance between the objective lens and the recording surface of the optical disc. In FIG. 8, an ordinate axis shows the amplitude of the focus error signal FE, and an abscissa axis shows the distance between the objective lens and the recording surface of the optical disc. Furthermore, in the abscissa axis of FIG. 8, the right direction indicates that the distance between the objective lens and the recording surface of the optical disc becomes shorter, and the left direction indicates that the distance between the objective lens and the recording surface of the optical disc becomes longer.

In FIG. 8, in the case where the distance between the objective lens and the recording surface of the optical disc is a point a, the focus error signal FE becomes a state shown in FIG. 7A. In the case where the distance between the objective lens and the recording surface of the optical disc is a point b, the focus error signal FE becomes a state shown in FIG. 7B. In the case where the distance between the objective lens and the recording surface of the optical disc is a point c, the focus error signal FE becomes a state shown in FIG. 7C.

FIG. 9 shows one example of a configuration of a conventional focus draw-in device. In FIG. 9, the optical disk 100 which an information signal is recorded on or reproduced from is rotated by a spindle motor 109. A focus actuator 107 moves the objective lens 108 perpendicular to the recording surface of the optical disk 100 to change a focus position. A signal detected by an optical sensor (four-element optical detector) 101 comprised of a plurality of (four in FIG. 9) light reception elements for receiving reflected light from the optical disk 100 is converted into the focus error signal FE by the error signal generator circuit 102. The focus error signal FE generated by the error signal generator circuit 102 is input via the focus control circuit 103 to the switch SW. The focus error signal FE is input also to the in-focus state detector 105. To the switch SW, the output signal of the sweep signal generator circuit 104 is also input. The output signal of the switch SW is input to the focus actuator 107 via a driver 106.

If the objective lens moves from an in-focus position and beyond a positive or negative maximum value of the focus error signal as shown in FIG. 8, the error signal is reduced as the objective lens goes away from the in-focus position, so that focus control becomes of negative feedback and so becomes unstable. Therefore, focus control needs to be performed in a negative feedback region of a distance over which the objective lens moves from the in-focus position to the positive or negative maximum value of the focus error signal, so that it is necessary for response of a position of the objective lens in an focus draw-in operation not to exceed this negative feedback region.

There is a strong need in the market for a decrease in recording time or an improvement in playback speed of the optical disk, so that it is necessary to rotate the optical disk as much as fast. A disk wobbling velocity due to face wobbling increases in proportion to the speed of rotation of the disk. Therefore, in condition where the disk is rotating fast, a relative velocity of the recording surface of the disk and the objective lens increases so that response of the objective lens in the focus draw-in operation cannot be contained in the negative feedback region, thus failing in focus draw-in. Failure in focus draw-in causes not only a problem of a prolonged lapse of time required to start recording or playback owing to retrial but also a significant problem that failure in drawing a focus in the negative feedback region makes the objective lens approach the disk surface further, which collides with the objective lens to damage the objective lens or the disk.

To solve these problems, the present invention has been developed, and it is an object of the present invention to provide a focus draw-in device that can provide a stable focus draw-in operation even in condition where an optical disk is rotating fast.

This object can be achieved by inventions described in claims.

In particular, the present invention comprises a sum signal generator for generating a sum signal by summing all outputs of the above-described four-element sensor used in detection of a focus error and a lens velocity control circuit for controlling a relative velocity of the optical disk and the objective lens according to the sum signal.

According to the present invention, a stable focus draw-in operation is enabled even in condition where the optical disk is rotating fast.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of a configuration of a first embodiment of a focus draw-in device of the present invention;

FIG. 2 is a graph of variations of a focus error signal FE and a sum signal PE with respect to a distance between an objective lens and a recording surface of an optical disk;

FIG. 3 is a block diagram of a configuration example of a lens velocity control circuit;

FIG. 4 is an explanatory graph of operations of the focus draw-in device of the first embodiment;

FIG. 5 is a block diagram of a configuration of a second embodiment of the focus draw-in device of the present invention;

FIG. 6 is an explanatory graph of operations of the focus draw-in device of the second embodiment;

FIGS. 7A to 7C are illustrations of condition of divided-by-four sensors and reflected light;

FIG. 8 is a graph of one example of the focus error signal;

FIG. 9 is a block diagram of a configuration of a conventional focus draw-in device; and

FIG. 10 is an explanatory graph of operations of the conventional focus draw-in device.

### DESCRIPTION OF THE EMBODIMENTS

The following will describe in detail embodiments of the present invention with reference to drawings.

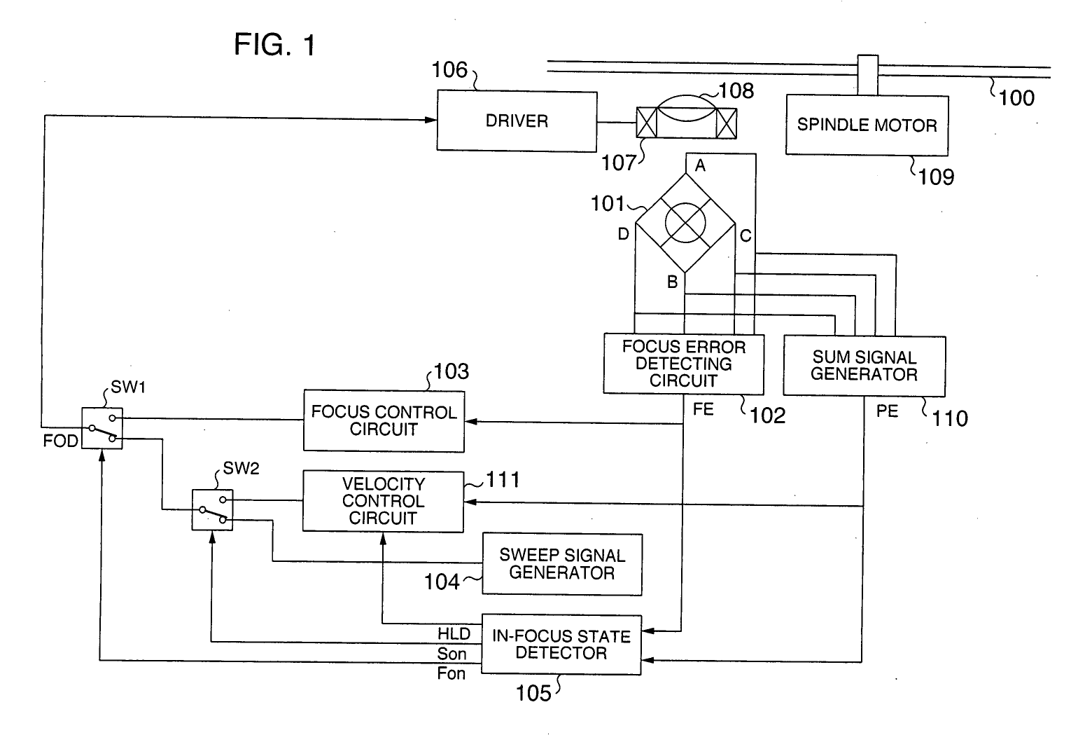

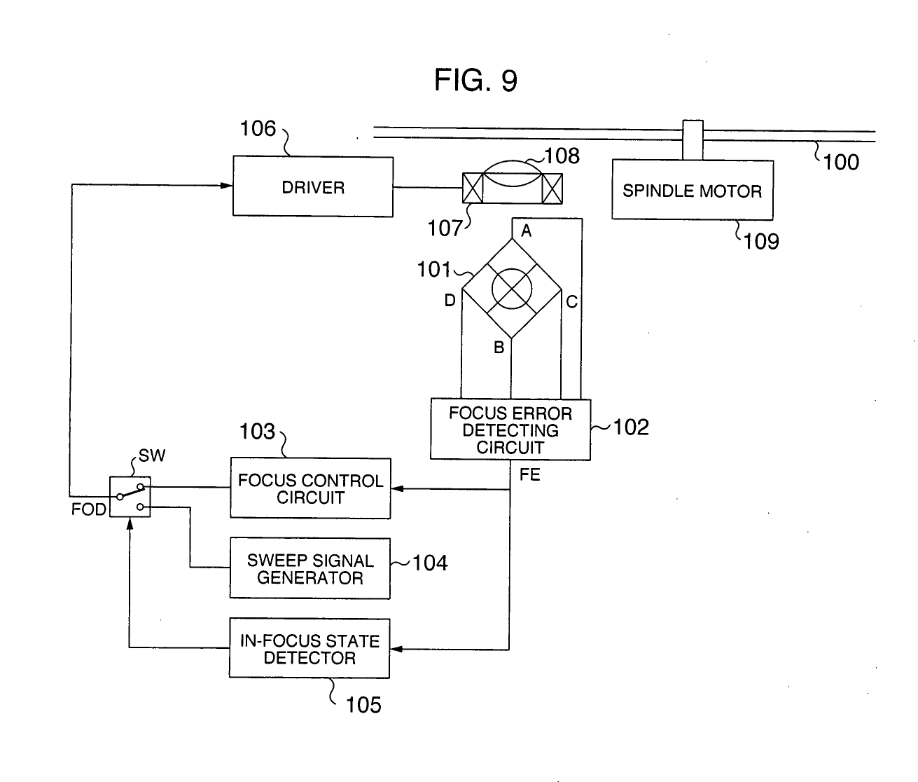

FIG. 1 is a block diagram of a configuration of a first embodiment of a focus draw-in device of the present invention. In FIG. 1, components that have the same functions as those of the conventional example of FIG. 9 are indicated by the same numerals and explanation of them is omitted.

In FIG. 1, numeral 110 indicates a sum signal generator circuit for calculating a sum of outputs of a four-element sensor 101 that detects a focus error signal and outputting a sum signal PE that indicates a sum reflected light quantity from an optical disk 100. Numeral 111 indicates a lens velocity control circuit for controlling a relative velocity of the optical disk 100 and an objective lens 108 based on the sum signal PE. SW1 indicates a switch for selecting an output of a focus control circuit 103 or that of SW2 and outputting the selected output and SW2 indicates a switch for selecting an output of the lens velocity control circuit 111 or that of a sweep signal generator circuit 104 and outputting the selected output.

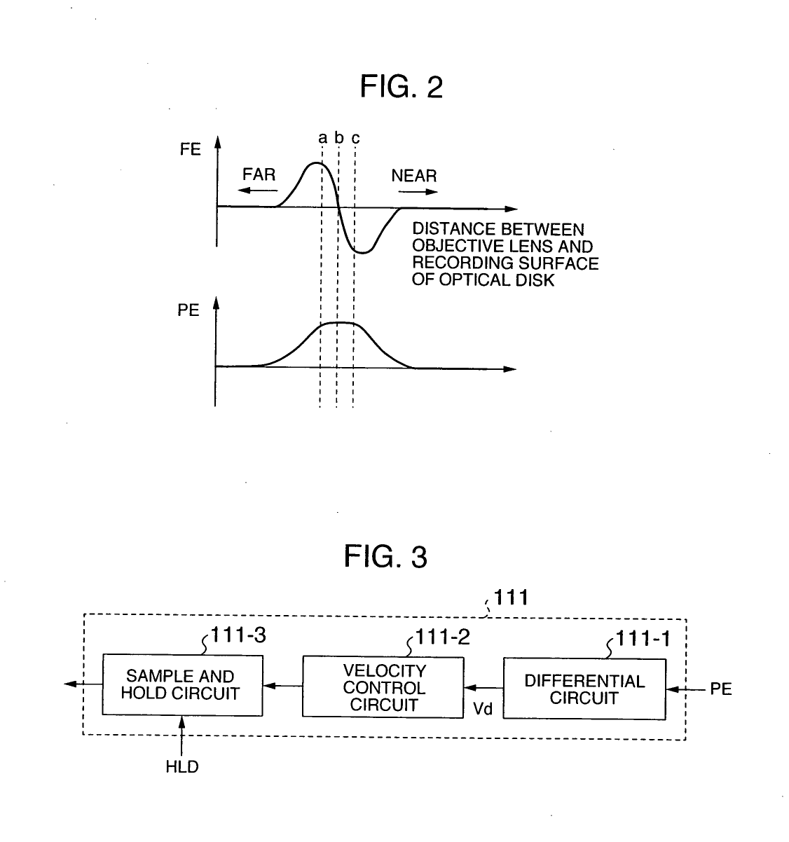

FIG. 2 shows variations of a focus error signal FE and the sum signal PE with respect to a distance between the objective lens and a recording surface of the optical disk. The focus error signal FE takes on a positive or negative polarity depending on a direction of displacement from an in-focus position and the sum signal PE is a positive-polarity signal that has a maximum amplitude at the in-focus position. Further, if the objective lens is displaced greatly from the in-focus position, reflected light from the optical disk diverges, so that output signals from the four-element sensor are almost equalized, thereby reducing the focus error signal FE to zero. In contrast, even in condition where reflected light from the optical disk has diverged due to large displacement of the objective lens from the in-focus position, the sum signal PE is detected as far as the reflected light is made incident upon the four-element sensor. Therefore, the sum signal PE is detected over a larger area than the focus error signal FE.

Next, operations of the present embodiment are described with reference to FIG. 1.

In focus control draw-in, first an Fon signal and an Son signal from the in-focus state detector 105 are used to switch output signals of the respective switches SW1 and SW2 so that an output of the sweep signal generator 104 may be provided. First, a sweep signal that increases in a negative direction is output from the sweep signal generator circuit 104 to move the objective lens 108 to a bottom point once and then a sweep signal that increases in a positive direction is generated therefrom to raise the objective lens 108 so that it may approach the recording surface of the disk. In the in-focus state detector 105, if the sum signal PE from the sum signal generator circuit 110 exceeds a predetermined level PEths, the Son signal causes the output signal of the switch SW2 to be switched to an output signal of the lens velocity control circuit 111. Accordingly, the objective lens 108 is switched to velocity control based on the sum signal PE, thereby performing control so that the relative velocity of the optical disk 100 and the objective lens 108 may become a predetermined velocity.

FIG. 3 shows a block diagram of a configuration example of the lens velocity control circuit 111.

In FIG. 3, numeral 111-1 indicates a differential circuit for calculating a time-wise variation in amplitude of the sum signal PE to detect a velocity signal Vd that corresponds to the relative velocity of the optical disk 100 and the objective lens 108. Numeral 111-2 indicates a velocity control circuit for outputting such a control signal that the relative velocity of the optical disk 100 and the objective lens 108 may become the predetermined velocity, based on the velocity Vd output from the differential circuit 111-1. Numeral 111-3 indicates a sample-and-hold circuit for holding an output of the velocity control circuit 111-2 by using an HLD signal from the in-focus state detector 105.

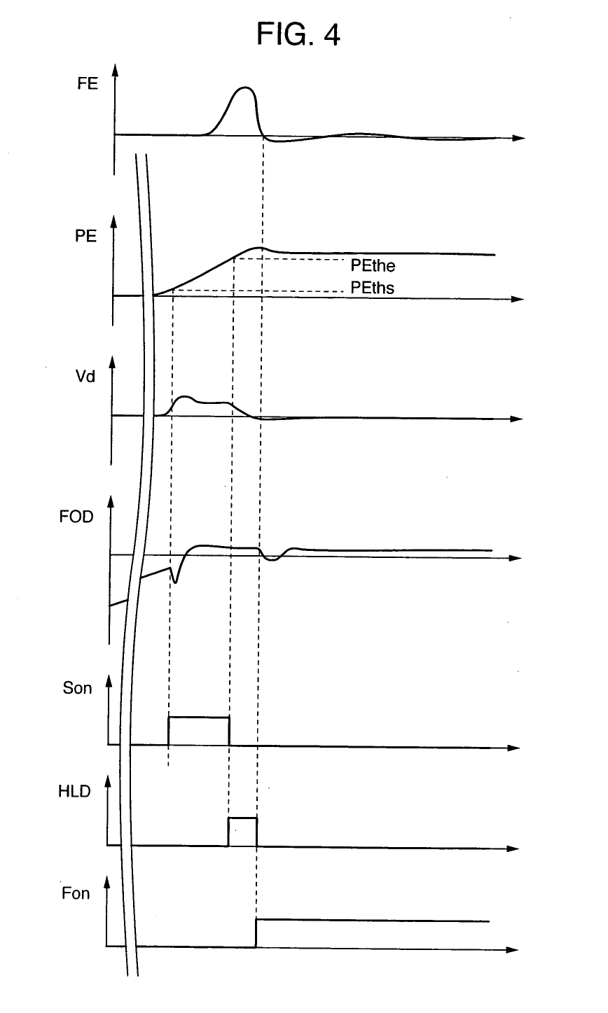

As shown in FIG. 4, as the lens approaches the in-focus position, the sum signal PE has a smaller variation with respect to the distance between the objective lens and the recording surface of the optical disk, to reduce a velocity detection sensitivity that is based on a time-wise variation in amplitude of the sum signal PE, thereby deteriorating control performance. Therefore, at a point in time when the sum signal PE exceeds a predetermined level PEthe, a hold signal HLD is output from the in-focus detector 105 to the lens velocity control circuit 111 so that the sample-and-hold circuit 111-3 may hold the output of the velocity control circuit 111-2 that is provided immediately before the hold signal HLD is switched. In such a manner, an actuator 107 is driven in such a direction that the objective lens 108 may approach the disk 100 at a relative velocity that is provided almost immediately before the holding.

At a point in time when the FE signal from the error signal generator 102 is reduced to 0 and the lens 108 has reached the in-focus position, the Fon signal from the in-focus state detector 105 causes the output signal of the switch SW1 to be switched to an output signal of the focus control circuit 103. In such a manner, the objective lens 108 is switched to a focus control operation by means of the output of the focus control circuit 103, thereby completing the focus draw-in operation.

It is thus possible to perform control so that the relative velocity of the recording surface of the optical disk and the objective lens may stably fall in a predetermined draw-in enabled range before control of the objective lens is switched to focus control by use of the focus error signal, thereby stabilizing the draw-in operation.

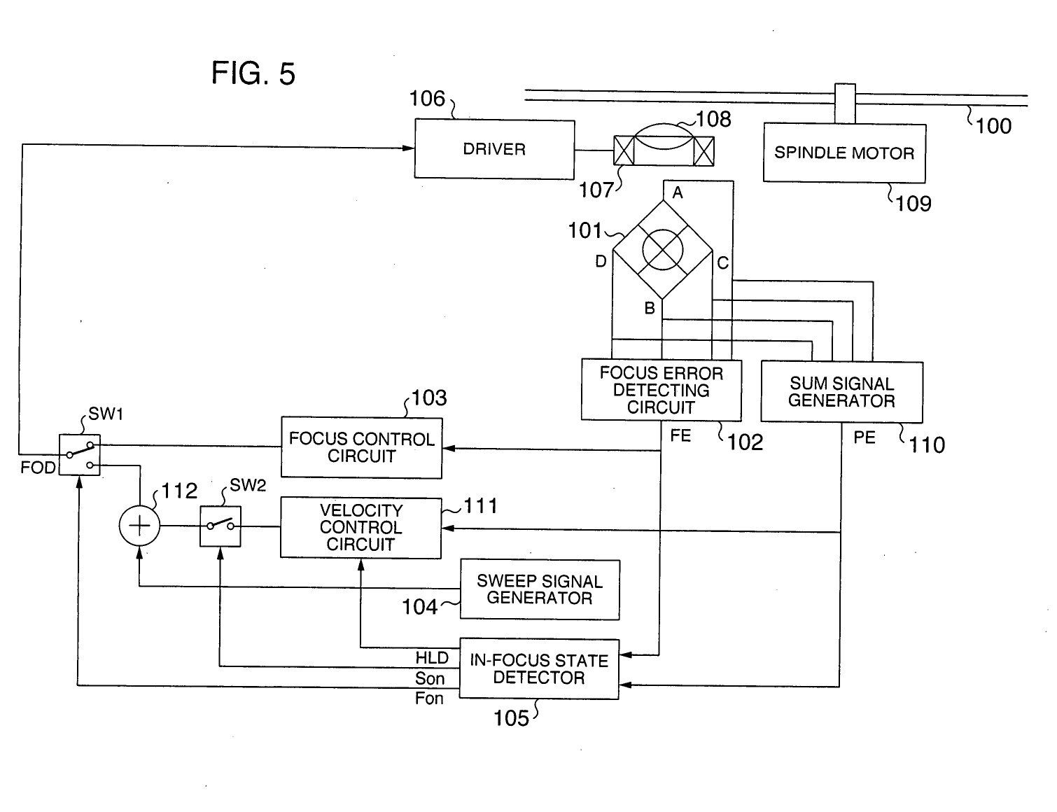

FIG. 5 is a block diagram of a configuration of a second embodiment of the focus draw-in device of the present invention. In FIG. 5, components that have the same functions as those of the conventional example of FIG. 9 are indicated by the same numerals and explanation of them is omitted.

In FIG. 5, SW1 indicates a switch for selecting and providing an output of a focus control circuit 103 or that of an adder 112, numeral 112 indicates an adder for summing an output of a switch SW2 and that of a sweep signal generator, and SW2 indicates a switch for turning ON/OFF transfer of an output of a lens velocity control circuit 111 to the adder.

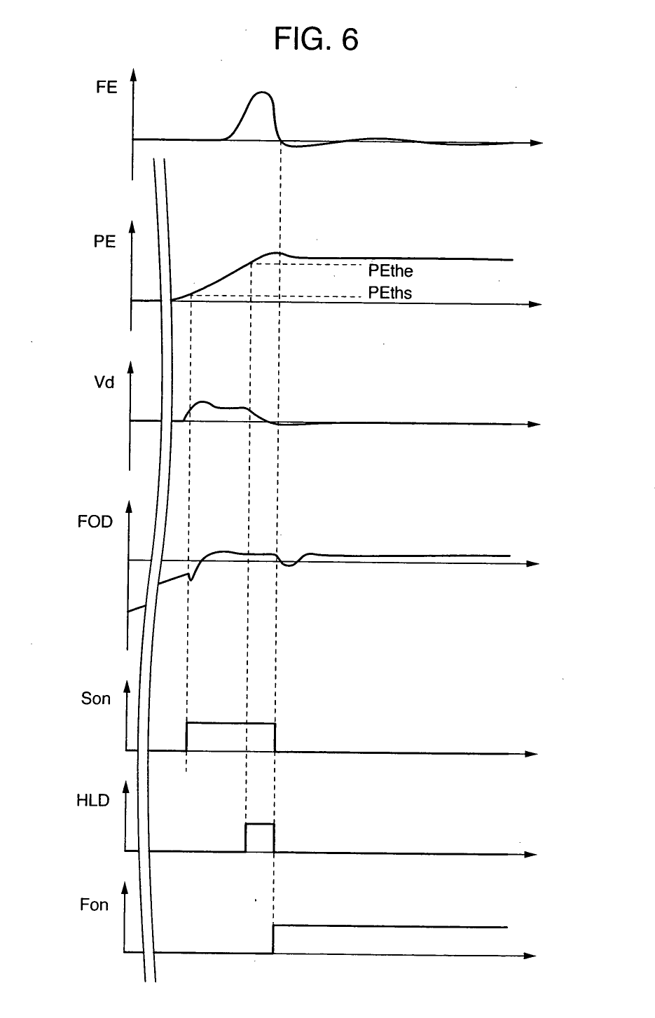

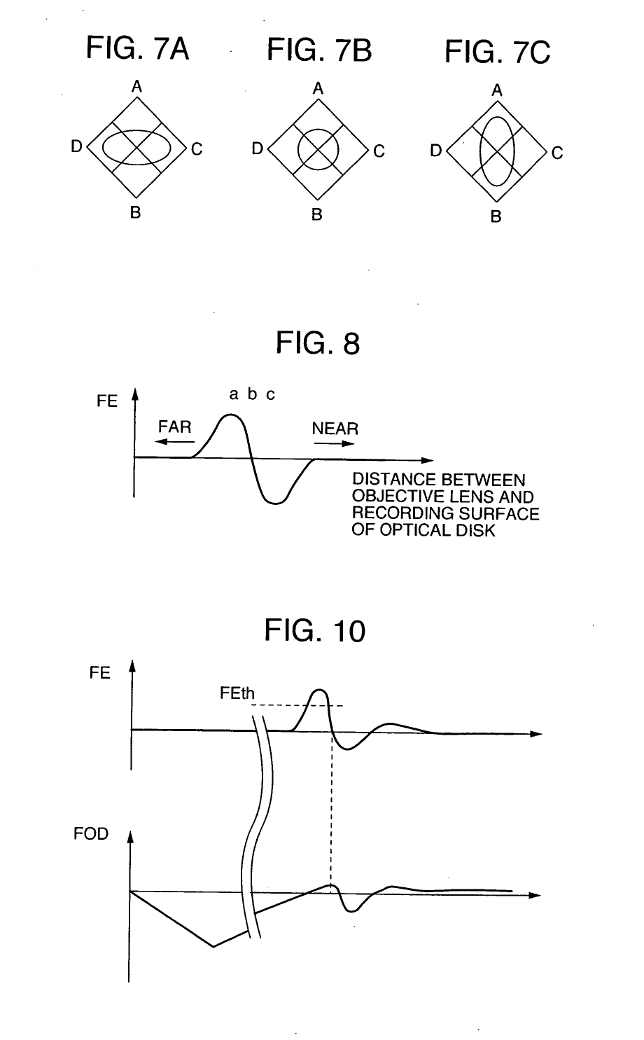

Next, operations of the present second embodiment are described with reference to FIGS. 5 and 6.

In focus control draw-in, first an Fon signal and an Son signal from an in-focus state detector circuit 105 cause the switch SW1 to be switched to an output of the adder and the switch SW2 to be switched to a turned-OFF state respectively. Accordingly, an output of a sweep signal generator circuit 104 is provided as a drive signal FOD from the switch SW1. First, a sweep signal that increases in a negative direction is output from the sweep signal generator circuit 104 to move an objective lens 108 to a bottom point once and then a sweep signal that increases in a positive direction is generated therefrom to raise the objective lens 108 so that it may approach a recording surface of a disk. In the in-focus state detector circuit 105, if a sum signal PE from a sum signal generator circuit 110 exceeds a predetermined level PEths, the Son signal causes the switch SW2 to be turned ON, thereby providing an output of the lens velocity control circuit 111 to the adder 112. The output of the sweep signal generator circuit 104 and the objective lens 108 are controlled by a drive signal to which a velocity control signal based on the sum signal PE is added, so that a relative velocity of an optical disk 100 and the objective lens 108 may become a predetermined velocity.

At a point in time when the sum signal PE exceeds a predetermined level PEthe, a hold signal HLD is output from the in-focus detector 105 to the lens velocity control circuit 111 so that the sample-and-hold circuit 111-3 may hold an output of the velocity control circuit 111-2 that is provided immediately before the hold signal HLD is switched. In such a manner, an actuator 107 is driven in such a direction that the objective lens 108 may approach the disk 100 at a relative velocity that is provided almost immediately before the holding.

At a point in time when the FE signal from an error signal generator circuit 102 is reduced to 0 and the lens 108 has reached an in-focus position, the Fon signal from the in-focus state detector 105 causes the output signal of the switch SW1 to be switched to an output signal of the focus control circuit 103. In such a manner, the objective lens 108 is switched to a focus control operation by means of the output of the focus control circuit 103, thereby completing a focus draw-in operation.

The second embodiment has such a merit that if an initial position of the objective lens 108 is greatly displaced from an in-focus position owing to the gravity, an insufficient accuracy of mechanism installation, etc., an output of the sweep signal generator 104 is added, as a drive signal to hold the objective lens 108 to an approximate focal position, to a signal to control and drive a velocity of the objective lens by using the lens velocity control circuit 111, thereby reducing an error in velocity control.

Although in the above embodiments the sum signal has been generated from the four-element sensor used in focus error detection, the present invention is not limited to it; a signal may be generated which corresponds to a quantity of reflected light from the disk. Further, the differential circuit for detecting the velocity Vd from the sum signal PE may be constituted of a high-pass filter having an appropriate cutoff frequency.

It should be further understood by those skilled in the art that although the foregoing description has been made on embodiments of the invention, the invention is not limited thereto and various changes and modifications may be made without departing from the spirit of the invention and the scope of the appended claims.

1. An optical disk device comprising:
a sensor which receives reflected light from an optical disk and outputs a plurality of sensor signals,
an error signal generator which combines the plurality of sensor signals of the sensor to generate a focus error signal,
a sum signal generator which combines the plurality of sensor signals of the sensor to generate a sum signal corresponding to a sum reflected light quantity from the disk,
a focus controller which inputs the focus error signal and outputs a drive signal,
an objective lens velocity controller which inputs the sum signal and outputs a drive signal,
a sweep signal generator which generates a drive signal which decreases or increases in a predetermined ratio to position the objective lens in the vicinity of a focus point of the optical disk,
a switch which selectively switches an output of the sweep signal generator, an output of the objective lens velocity controller and an output of the focus controller to output a drive signal,
a drive unit which drives the objective lens in accordance with an output of the switch,
a comparator which compares the sum signal with a predetermined value to output a signal, and
an in-focus state detector which compares the focus error signal with a predetermined value to detect that the objective lens is positioned at an in-focus,
wherein the drive signal output from the switch is switched in accordance with outputs of the comparator and the in-focus detector.

2. The optical disk device according to claim 1, comprising sample-and-hold circuit which holds an output of the objective lens velocity controller, wherein:
the comparator has a first comparison value and a second comparison value; and
when it is detected that the sum signal has exceeded the first comparison value, the drive signal output from the switch is switched from an output of the sweep signal generator to an output of the objective lens velocity controller, when the sum signal exceeds the second comparison value, the output of the objective lens velocity controller is held by the sample-and-hold circuit, and when it is detected by the in-focus state detector that the objective lens is positioned at the in-focus, an output of the switch is switched to an output of the focus controller.

3. The optical disk device according to claim 2, wherein the objective lens velocity controller includes a velocity detector which differentiates the sum signal to detect a relative velocity of the objective lens and the optical disk, and a velocity controller which outputs a drive signal based on an output of the velocity detector.

4. The optical disk device according to claim 1, wherein the objective lens velocity controller includes a velocity detector which differentiates the sum signal to detect a relative velocity of the objective lens and the optical disk, and a velocity controller which outputs a drive signal based on an output of the velocity detector.

5. An optical disk device comprising:
a sensor which receives reflected light from an optical disk and outputs a plurality of sensor signals,
an error signal generator which combines the plurality of sensor signals of the sensor to generate a focus error signal,
a sum signal generator which combines the plurality of sensor signals of the sensor to generate a sum signal corresponding to a sum reflected light quantity from the disk,
a focus controller which inputs the focus error signal and outputs a drive signal,
an objective lens velocity controller which inputs the sum signal and outputs a drive signal,
a sweep signal generator which generates a drive signal which decreases or increases in a predetermined ratio to position the objective lens in the vicinity of a focus point of the optical disk,
an adder which adds an output of the sweep signal generator to an output of the objective lens velocity controller,
a switch which selectively switches an output of the focus controller and an output of the adder to output a drive signal,
a drive unit which drives the objective lens in accordance with an output of the switch,
a comparator which compares the sum signal with a predetermined value to output a signal, and
an in-focus state detector which compares the focus error signal with a predetermined value to detect that the objective lens is positioned at an in-focus,
wherein the drive signal output from the switch is switched in accordance with outputs of the comparator and the in-focus detector.

6. An optical disk device comprising:
a sensor which receives reflected light from an optical disk and outputs a plurality of sensor signals,
an error signal generator which combines the plurality of sensor signals of the sensor to generate a focus error signal,
a drive unit which drives an objective lens,
a sum signal generator which combines the plurality of sensor signals of the sensor to generate a sum signal corresponding to a sum reflected light quantity from the disk,
a focus controller which inputs the focus error signal and outputs a drive signal,
an objective lens velocity controller which inputs the sum signal and outputs a drive signal, and
a sweep signal generator which generates a drive signal which decreases or increases in a predetermined ratio to position the objective lens in the vicinity of a focus point of the optical disk,
wherein an output of the sweep signal generator, an output of the objective lens velocity controller and an output of the focus controller are switched in this order to output a drive signal, whereby a focus draw-in operation is performed.

7. A method for performing a focus draw-in operation on an optical disk device comprising a sensor which receives reflected light from an optical disk and outputs a plurality of sensor signals, an error signal generator which combines the plurality of sensor signals from the sensor to generate a focus error signal, and an objective lens drive unit which drives an objective lens, the method comprising the steps of:
outputting a drive signal that decreases or increases in a predetermined ratio to the objective lens drive unit to position the objective lens in the vicinity of a focus position of the optical disk;
combining the plurality of sensor signals from the sensor to supply the objective lens drive unit with a drive signal that controls a velocity of the objective lens based on a sum signal that corresponds to a sum quantity of the reflected light from the disk;
inputting the focus error signal and supplying the objective lens drive unit with a drive signal that controls the focus; and
outputting the drive signals to the objective lens drive unit as serially switching the drive signals, to perform the focus draw-in operation.
